(19) United States
(12) Patent Application Publication
(10) Pub. No.: US 2024/0218304 A1
(43) Pub. Date: Jul. 4, 2024

(54) THERAPEUTIC ALCOHOLIC BEVERAGE COMPRISING NATURAL HERBAL DERIVATIVES AND METHOD OF MAKING THEREOF

(71) Applicants: Mark DeCaro, Avon by the Sea, NJ (US); Guobao Wei, Milltown, NJ (US)

(72) Inventors: Mark DeCaro, Avon by the Sea, NJ (US); Guobao Wei, Milltown, NJ (US)

(73) Assignees: Mark DeCaro, Avon by the Sea, NJ (US); Guobao Wei, Milltown, NJ (US)

(21) Appl. No.: 18/148,480

(22) Filed: Dec. 30, 2022

(51) Int. Cl. C12G 3/055; C12G 3/07

(52) U.S. Cl. CPC C12G 3/055; C12G 3/07

(57) ABSTRACT

Therapeutic alcoholic beverage compositions and the methods of making are disclosed. In particular, the invention relates to a therapeutic alcoholic beverage composition comprising one or more therapeutic compounds derived from natural herb materials. The natural herb materials are selected from Cannabis materials, psilocybin mushrooms, the combination of those, and others. The therapeutic compounds comprising psychoactive compounds Δ⁹-tetrahydrocannabinol (THC), supporting non-psychoactive cannabidiol (CBD) and terpenes derived from Cannabis materials, and/or psychedelic compounds including psilocybin, psilocin, baeocystin, norbaeocystin, and norpsilocin derived from psilocybin mushrooms. The therapeutic compounds have a concentration varying from 0.00001% to 10% in the alcoholic beverage. The therapeutic alcoholic beverage can be further enhanced by aroma and flavor substances derived from wood materials. The methods of making comprising treating alcoholic beverage with natural herb materials and wood materials in presence of subcritical, critical, or supercritical carbon dioxide.

### FIELD OF THE INVENTION

The present invention relates to novel alcoholic beverage compositions enhanced with therapeutic herbal derivatives and the methods of enhancement. More specifically, the invention utilizes a subcritical/critical/supercritical carbon dioxide (CO₂) process to infuse alcoholic beverage with therapeutic derivatives from natural herb materials such as Cannabis plants, psilocybin mushrooms, the combination of those, with or without flavor and aroma compounds from wood materials.

### BACKGROUND

Humans have produced alcohols for consumption for thousands of years and alcoholic beverage continues to be consumed worldwide despite known deleterious effects due to excess and/or chronic consumption. Over the years, humans have innovated technologies to improve the drinkability of alcoholic beverages from cultivation and selection of raw materials, fermentation, distillation, to storage and aging processes [Atanu Konwar: A Review On: Fermented Alcoholic Beverages; Its Preservation, Shelf Life Extension And Value Addition. Current Trends in Pharmaceutical Research, 2022, 8(2): 54-72. Roselini Trapp Krüger, Aline Alberti and Alessandro Nogueira: Current Technologies to Accelerate the Aging Process: A Review. Beverages 2022, 8(4): 65-86. Mark DeCaro, Guobao Wei: Accelerated Spirit/Beverage Aging and Flavor Loading Methods and Systems. 2020, U.S. Pat. No. 10,633,620B2]. Recent attentions have been focused on infusing and impregnating of various beneficial substances or components into alcoholic beverages to improve the aroma and taste profiles [Denisley Gentil Bassoli: Spirit Infused Coffee Beans. US Patent application 20190387764. Giuseppe Gallo: Spirit Drink. US Patent application 20190338228]. A variety of therapeutic herb materials are particular candidates for infusing or impregnating to potentially treat physical and mental diseases or disorders, to improve health conditions and to offer recreational benefits with the resulting therapeutic alcoholic beverages.

The Cannabis plant is a complex plant containing more than 400 distinct chemical entities, of which more than 60 are cannabinoid compounds [Ethan B Russo, Cannabis and Cannabinoids: Pharmacology, Toxicology, and Therapeutic Potential, 1^{st} Edition 2002]. Δ⁹-Tetrahydrocannabinol (THC) is the cannabinoid most known for its psychoactive properties while Cannabidiol (CBD), known as lacking the psychoactive effect that Δ⁹-Tetrahydrocannabinol (THC) has, was shown to be clinically useful to reduce inflammation, alleviate nausea and emesis, treat epilepsy, anxiety disorders, or glaucoma. It was also shown to actually counteract the psychoactivity of THC and thus reduce some of the side effects of THC if the THC/CBD ratio is properly adjusted [Scott et al., The Combination of Cannabidiol and A9-Tetrahydrocannabinol Enhances the Anticancer Effects of Radiation in an Orthotopic Murine Glioma Model. Molecular Cancer Therapeutics, 2014, 13(12): 2955-2967]. Various studies have also demonstrated that CBD can attenuate binge alcohol-induced neurodegeneration [Daniel J. Liputa, et al., Transdermal Delivery of Cannabidiol Attenuates Binge Alcohol-induced Neurodegeneration in a Rodent Model of an Alcohol Use Disorder, Pharmacology Biochemistry and Behavior, 2013, 111:120-127]. Cannabinoids possess the characteristics of being cyclic molecules exhibiting particular properties such as the ability to easily cross the blood-brain barrier, weak toxicity and few side effects. Besides the cannabinoids, terpenes are the organic hydrocarbons responsible for the aroma and flavor of Cannabis derived materials and products. There have been more than 100 terpenes found in different Cannabis strains. Terpenes from Cannabis plants are valuable as they are not only responsible for a given strain's aroma and flavor profiles but also are rich in their own medicinal effects although they are non-psychoactive themselves. In addition, terpenes are found to exponentially increase the effectiveness of THC and CBD molecules which is referred as the “entourage effect” [Ethan B Russo, Taming THC: Potential Cannabis synergy and phytocannabinoid-terpenoid entourage effects. British Journal of Pharmacology, 2011 163: 1344-1364]. Different combinations of cannabinoids and terpenes alter the way the brain responds to produce unique effects.

In Cannabis plant, cannabinoids are synthesized and accumulated as cannabinoid acids. When the Cannabis material is dried and heated, the acids decarboxylate gradually into their proper active forms, such as CBD or Δ⁹-THC [De Meijer et al., The Inheritance of Chemical Phenotype in Cannabis sativa L. Genetics, 2003, 163(1): 335-346]. The heating conditions including atmosphere oxygen content, temperature, pressure, and time etc. impact the activation of THC, CBD and/or the respective terpene profiles.

Psilocybin is a naturally occurring psychedelic compound produced by more than 200 species of mushrooms, collectively known as psilocybin mushrooms or magic mushrooms. Psilocybin, also known as 3-[2-(Dimethylamino)ethyl]-1H-indol-4-yl dihydrogen phosphate, is considered to be the most abundant psychedelic compound within magic mushrooms. Psilocin, 4-hydroxy-N,N-dimethyltryptamine, is a substituted tryptamine alkaloid and a serotonergic psychedelic substance. Once digested, psilocybin is metabolized to psilocin which acts on serotonin receptors in the brain. The psychedelic effects of psilocybin and psilocin typically last from 2-6 hours. The active ingredients psilocin and its prodrug psilocybin are low toxic and have been found to have therapeutic properties including relief of symptoms of various diseases and conditions. The psychological therapeutic benefits of psilocybin mushrooms include treating mood and neurological disorders, such as depression, attention deficit hyperactivity disorder, compulsive disorder, anxiety disorder, cluster headaches, and anxiety related to terminal cancer.

Thanks to the medicinal and therapeutic effect of Cannabis derived compounds such as THC and CBD and the versatile aroma profiles from Cannabis terpenes, there has been increased interest in utilizing those compounds through various delivery vehicles. Especially there are needs of infusing those Cannabis derived compounds into consumable alcoholic drinks such as distilled spirit, spirits, wine and beer. However, there are unique and dynamic challenges that come along with developing sustainable Cannabis infused alcoholic beverages. US Pat. Appl. 20120124704 disclosed a method of infusing Cannabis by direct soaking the Cannabis matter in a consumable alcoholic drink. The process itself is not efficient and the extraction of active Cannabis compounds CBD and THC by consumable alcoholic beverages is too low to achieve their expected medicinal effects. U.S. Pat. Nos. 9,642,884 and 10,085,965 disclosed a cannabinoid alcoholic drink and the producing method. It used a small amount of ethanol (high alcohol percentage) to fully dissolve cannabinoid or CBD and then combined with consumable alcohols such as vodka to yield the cannabinoid/vodka or cannabidiol/vodka drink. US patent application US2019017767 also disclosed a similar method to produce cannabinoid enriched alcohol beverage by combining cannabinoid oil/ethanol emulsion or suspension with distilled spirit. These methods add pure ethanol to the consumable alcoholic drink thus significantly alters the original drink compositions and are not ideal.

Magic mushrooms are taken recreationally by millions of people in whole or raw powder format. Despite their popularity and commercial success, direct consumption of magic mushroom has disadvantages including poor efficacy, long and varied onset time, and possible severe side-effects. Formulated and administered correctly, psilocin and psilocybin provide fast-acting and long-lasting changes to a person's mood. These effects can be accomplished with only minor side effects, low potential for addiction, low potential for abuse, and low risk of toxicity.

US patent application 20220226405 disclosed a method of extracting psychoactive compounds from organisms for use in medicine. The method utilizes a strong acid or strong base for extraction. A large portion of target active compounds can be lost during the extraction process or have reduced activity due to harsh extraction conditions. Solvents used in extraction methods such as methanol, acetone, diethyl ether, acid, base or others are known to be toxic to humans even in small quantities. The therapeutical effects of extracted psychoactive compounds cannot be optimized.

Therefore, there is a need for an enhanced alcoholic beverage infused with therapeutic compounds from natural herb materials. The therapeutic alcohol beverage should be safe to consume as current commercial alcohol drinks and provide extra long-term medicinal benefits for improving physical and mental health conditions. In addition, for some alcoholic beverages such as distilled spirits (tequila, whisky etc.), they are consumed after aging for improved quality complexities such as appearance, smell, taste and other quality complexities imparted by the aging process. The distilled spirits are aged in a wood barrel or through an accelerated aging method. Therefore, there is also a need for an alcoholic beverage comprising both natural herb derived therapeutic agents and wood material derived complexities. And methods of making such therapeutic alcohol beverages are needed.

### BRIEF SUMMARY OF THE INVENTION

It is an objective of the present invention to provide a therapeutic alcoholic beverage composition enhanced with natural herb derived compounds. In some embodiments, the therapeutic alcoholic beverage contains psychoactive Δ⁹-tetrahydrocannabinol (THC), non-psychoactive cannabidiol (CBD), terpenes, or combination thereof derived from Cannabis materials in a ratio of 0.00001%-10% (w/v %), preferably in a ratio of 0.005%-0.5% (w/v %). The resulting therapeutic alcoholic beverage has a clear light golden color with an additional aroma profile derived from Cannabis materials. In some other embodiments, the therapeutic alcoholic beverage contains psychedelic compounds including but not limit to psilocybin, psilocin, baeocystin, norbaeocystin, norpsilocin derived from psilocybin mushrooms in a ratio of 0.00001%-10% (w/v %), preferably in a ratio of 0.005%-0.5% (w/v %). The resulting therapeutic alcoholic beverage has a clear light golden color with an additional aroma profile derived from magic mushrooms. In some other embodiments, the therapeutic alcoholic beverage contains therapeutic compounds derived from both Cannabis materials and magic mushrooms. The ratios of selected Cannabis materials to magic mushrooms vary from 1:100 to 100:1.

It is another objective to provide an alcoholic beverage enhanced with both natural herb material and wood derived compounds. In some embodiments, the therapeutic alcoholic beverage contains psychoactive Δ⁹-tetrahydrocannabinol (THC), non-psychoactive cannabidiol (CBD), terpenes, or combination thereof derived from Cannabis materials in a ratio of 0.00001%-10% (w/v %), preferably in a ratio of 0.005%-0.5% (w/v %). The resulting therapeutic and aged alcoholic beverage composition has clear golden color with aroma and flavor profiles derived from both Cannabis and wood materials. In some other embodiments, the therapeutic alcoholic beverage contains psychedelic compounds including but not limit to psilocybin, psilocin, baeocystin, norbaeocystin, norpsilocin derived from psilocybin mushrooms in a ratio of 0.00001%-10% (w/v %), preferably in a ratio of 0.005%-0.5% (w/v %). The resulting therapeutic and aged alcoholic beverage composition has clear golden color with aroma and flavor profiles derived from both mushroom and wood materials.

It is a further objective to provide a method for enhancing alcoholic beverages via an in-situ subcritical/critical/supercritical CO₂ infusion process. In some embodiments, the natural herb materials such as Cannabis materials and/or psilocybin mushrooms are soaked with alcoholic beverages in the presence of subcritical/critical/supercritical carbon dioxide fluid. In some other embodiments, both natural herb materials and wood materials are soaked with alcoholic beverages in the presence of subcritical/critical/supercritical carbon dioxide fluid. The ratio of natural herb materials to wood materials can be from 1:100 to 100:1. After completion of infusion process, carbon dioxide is released to obtain various therapeutic or therapeutic and aged alcoholic beverages.

In various embodiments, the Cannabis materials comprising the buds, flowering tops (flowers), leaves, stalks, seeds, the combination thereof or any other portion of a Cannabis plant include but not limit to a Cannabis sativa or a Cannabis indica plant.

In various embodiments, the Cannabis derived compound is at least one of cannabinoid forms comprising Δ⁹-tetrahydrocarmabinol (THC), cannabidiol (CBD), Δ⁸-tetrahydrocannabinol (Δ⁸-THC), cannabichromene (CBC), cannabigerol (CBG), cannabicyclol (CBL), cannabielsoin (CBE), cannbinidiol (CBND), cannabinol (CBN), and cannabitriol (CBT) and at least one of the terpenes comprising myrcene, pinene, linalool, carene, caryophyllene, nerol, geraniol, limonene, terpinolene, valencene, and humulene.

In various embodiments, the Cannabis materials and the psilocybin mushrooms are fresh or further treated by various processes including but not limited to sun drying, air drying, vacuum drying, heat drying, lyophilization, critical point drying, heating, and the combination thereof.

In various embodiments, the wood materials can be from oak, cherry, hickory, cedar, maple, redwood, palm, chestnut, acacia, apple, ash, alder, pecan, almond, peach, apricot, lemon, birth, beech, plum, walnut, grapefruit, sycamore, and the combination thereof. The wood aroma and flavor compounds include but not limited to at least one of vanillin, oak lactone, furfural/methylfurfural, eugenol/isoeugenol, guaiacol/methylguaiacol, etc.

In various embodiments, the wood materials can be fresh or further treated by various processes including but not limited to sun drying, air drying, vacuum drying, heat drying, lyophilization, critical point drying, heating, toasting, baking, flare charring, and the combination thereof.

In various embodiments, the therapeutic alcoholic beverage is enhanced from an alcoholic beverage comprising at least one of distilled spirits, bourbon, whiskey, tequila, gin, brandy, scotch, vodka, rum, wine, and beer.

In various embodiments, the therapeutic alcoholic beverage is enhanced from an aged alcoholic beverage. Aged alcoholic beverages can be obtained by aging the alcoholic beverage through a traditional barrel aging process for no more than 30 years or other accelerated aging methods.

### BRIEF DESCRIPTION OF THE DRAWINGS

FIG. 1 illustrates a flow chart of enhancing alcoholic beverages with therapeutic herb derived compounds in an in-situ subcritical/critical/supercritical CO₂ infusing process.

FIG. 2 illustrates a flow chart of enhancing alcoholic beverages with both therapeutic herb materials and wood materials derived compounds in an in-situ subcritical/critical/supercritical CO₂ infusing process. Both herb and wood materials are pre-treated or activated.

FIG. 3 illustrates a flow chart of enhancing alcoholic beverages with both therapeutic herb materials and wood materials derived compounds in an in-situ subcritical/critical/supercritical CO₂ infusing process. Both therapeutic herb and wood materials used are in various combinations of fresh and pre-treated/activated materials.

FIG. 4 shows various tequila samples. Control 1, Plata tequila purchased from a liquor store; Comp A, Therapeutic tequila infused with Cannabis derived compounds; Comp B, Therapeutic tequila infused with both Cannabis and oak wood derived compounds; Control 2, Tequila infused with oak wood derived compounds; and Control 3, Reposado Tequila (minimum 2 months oak barrel aged) from the same brand as Control 1.

FIG. 5 shows various tequila samples. Control 1, Plata tequila purchased from a liquor store; Comp B, Therapeutic tequila infused with both Cannabis and oak wood derived compounds at low supercritical CO₂ temperature 55° C.; Comp B, Therapeutic tequila infused with both Cannabis and oak wood derived compounds at high supercritical CO₂ temperature 95° C.

FIG. 6 shows various spirit samples. A) Tequila samples: Control 1, Plata tequila purchased from a liquor store; Comp D, Therapeutic tequila infused with magic mushroom. B) Vodka samples: Control 4, Prairie Organic Vodka purchased from a liquor store; Comp E, Therapeutic Vodka infused with both Cannabis and magic mushroom derived compounds; Comp F, Therapeutic Vodka infused with Cannabis material derived compounds only.

### DETAILED DESCRIPTION OF THE INVENTION

For the purposes of promoting an understanding of the principles of the disclosure, reference will now be made to certain embodiments and specific language will be used to describe the same. It will nevertheless be understood that no limitation of the scope of the disclosure is thereby intended, such alterations and further modifications in the illustrated methods of aging alcoholic beverages and beverages, and such further applications of the principles of the disclosure as described herein being contemplated as would normally occur to one skilled in the art to which the disclosure relates.

Additionally, unless defined otherwise or apparent from context, all technical and scientific terms used herein have the same meanings as commonly understood by one of ordinary skill in the art to which this disclosure belongs.

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Similarly, when values are expressed as approximations, by use of the antecedent “about,” it will be understood that the particular value forms another embodiment that is +/−10% of the recited value. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Critical carbon dioxide (CO₂), as used herein, refers to carbon dioxide at a temperature and pressure reached its thermodynamic critical point at temperature of 31.1° C. and pressure of 1100 psi. Under these conditions, the distinction between gases and liquids does not apply and the CO₂ is described as a fluid. Below its critical point, the CO₂ is subcritical CO₂.

Supercritical carbon dioxide, as used herein, refers to carbon dioxide (CO₂) above its thermodynamic critical point (i.e., above critical temperature of 31.1° C. and pressure of 1100 psi). Under these conditions, the supercritical carbon dioxide has the ability to diffuse through solids like a gas, and dissolve materials like a liquid. Additionally, a supercritical carbon dioxide can readily change in density upon minor changes in temperature or pressure. Supercritical carbon dioxide is an excellent non-polar solvent for many organic compounds. It has been likened to a solvent resembling hexane, though with some hydrogen-bonding acceptor capability and some dipole selectivity. Alkenes, alkanes, aromatics, ketones, and alcohols (up to a relative molecular mass of around 400) dissolve in supercritical carbon dioxide. Very polar molecules such as sugars or amino acids and most inorganic salts are insoluble. By adjusting the pressure of the fluid, the solvent properties can be adjusted to more “gas-like” or more “liquid-like”, which allows tuning of the solvent properties.

New therapeutic alcoholic beverages and their making methods and processes are disclosed in this invention. The present application is directed to the use of subcritical/critical/supercritical carbon dioxide (CO₂) in infusing alcoholic beverages with compounds derived from natural therapeutic herb materials or the combination of natural therapeutic herb materials and wood materials. Subcritical/critical/supercritical CO₂ acts as a non-polar solvent, co-acted with alcohols from the alcoholic beverage, to selectively extract a spectrum of compounds from herb materials or the combination of herb and wood materials. The in-situ extracted compounds directly react with alcoholic beverage to result in therapeutic alcoholic beverages in a short time period. Infused in alcoholic beverage, the extracted compounds provide respective therapeutic, medicinal, aroma, and flavor profiles to the alcoholic beverage. At the end of the process, carbon dioxide is removed easily without leaving any unwanted/toxic residues in the enhanced alcoholic beverages. The entire process is carried out in an oxygen free environment which prevents oxidation damages to the therapeutic compounds and alcoholic beverage at an elevated temperature.

The therapeutic effects of the resulting enhanced alcoholic beverage are originated from the compounds derived from natural herb materials. The therapeutic compounds can be psychoactive molecules from Cannabis materials, psychedelic molecules from mushroom and fungi materials, ancillary molecules (non-psychoactive or non-psychedelic but supporting psychoactive and/or psychedelic effects) from both Cannabis and fungi materials, or the combination of thereof.

The Cannabis derived compounds with therapeutic benefits include but are not limited to psychoactive molecules Δ⁹-tetrahydrocarmabinol (THC) and Δ⁸-tetrahydrocannabinol (Δ⁸-THC), and other ancillary molecules cannabidiol (CBD), cannabichromene (CBC), cannabigerol (CBG), cannabicyclol (CBL), cannabielsoin (CBE), cannbinidiol (CBND), cannabinol (CBN), cannabitriol (CBT), and the combination thereof. The ancillary molecules can augment and balance the psychoactivity from THC molecules. The mushroom and fungi derived compounds include but are not limited to psychedelic psilocybin, psilocin, baeocystin, norbaeocystin, norpsilocin, and the combination thereof.

When both psychoactive and psychedelic molecules are infused in the alcoholic beverage, the resulting therapeutic alcohol beverage may present synergetic effects for disease control and treatment.

Some ancillary compounds contribute to the overall aroma and flavor profiles of the resulting therapeutic alcoholic beverages. The molecules include but not limited to terpenes from Cannabis materials, the flavor compounds derived from mushrooms and fungi, the compounds derived from wood materials, or the combination thereof. The terpenes derived from Cannabis materials comprises at least one of myrcene, pinene, linalool, carene, caryophyllene, nerol, geraniol, limonene, terpinolene, valencene, and humulene. The mushroom and fungi derived compounds include but not limited to C8 compounds oct-1-en-3-ol, octan-3-ol, octan-3-on and oct-1-en-3-on, and the combination thereof. The aroma and flavor compounds derived from oak wood include but are not limited to tannin, vanillin, lactones, furfural, methylfurfural, eugenol, isoeugenol, guaiacol, methylguaiacol, and ethylphenol, and the combination thereof.

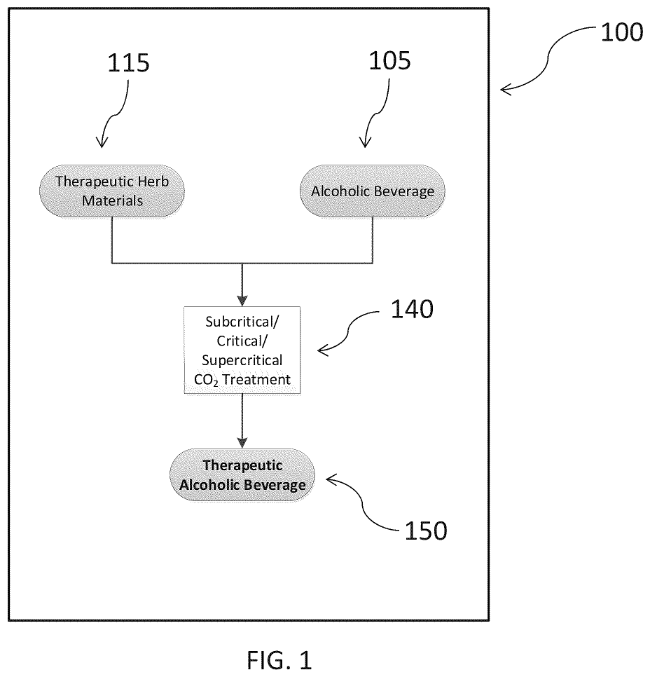

FIG. 1 illustrates a flow diagram of an in-situ enhancing method 100 to obtain a therapeutic alcoholic beverage 150. Natural herb materials 115 are mixed with alcoholic beverage 105 in a subcritical/critical/supercritical carbon dioxide process 140 to obtain a therapeutic alcoholic beverage 150.

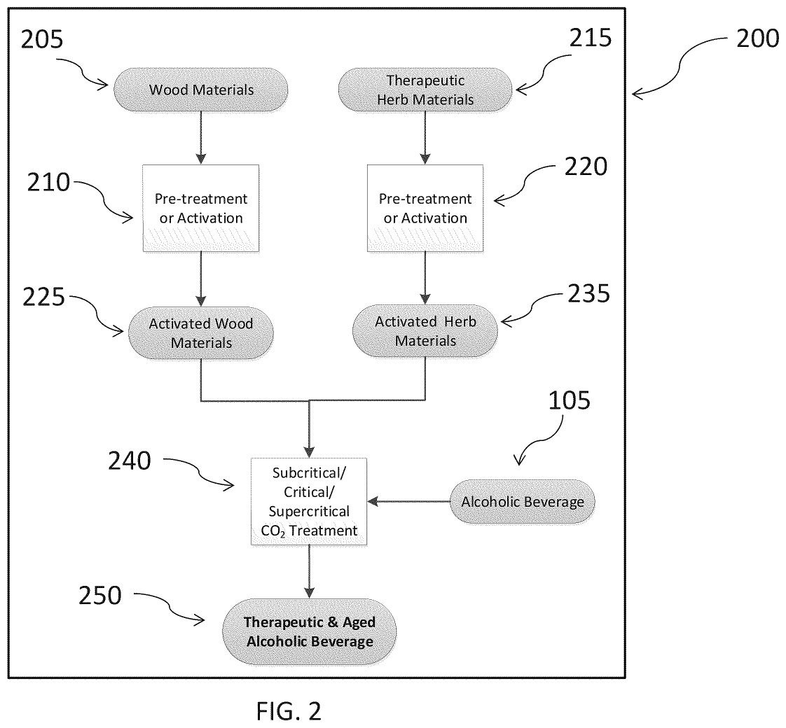

FIG. 2 illustrates a flow diagram of another in-situ enhancing method 200 to obtain a therapeutic alcoholic beverage 250. The process starts with natural herb materials 215 and wood materials 205. Wood materials are treated at step 210 to obtain activated wood materials 225 while natural herb materials are treated in process step 220 to activate the components in the materials. Activated herb material 235 and activated wood materials 225 are then mixed with alcoholic beverage 105 in a subcritical/critical/supercritical carbon dioxide process 240 to obtain a therapeutic and aged alcoholic beverage 250.

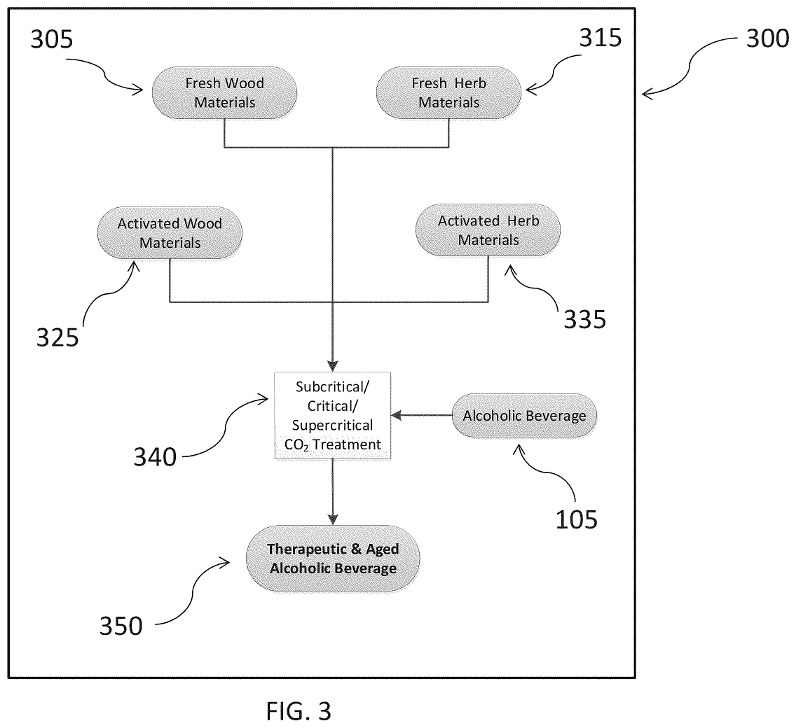

FIG. 3 illustrates a flow diagram of yet another in-situ enhancing method 300 to obtain a therapeutic alcoholic beverage 350. The process combines fresh wood materials 305, activated wood materials 325, fresh herb materials 315, and activated herb materials 335 with alcoholic beverage 105 in a subcritical/critical/supercritical carbon dioxide process 340 to obtain a therapeutic and aged alcoholic beverage 350.

In some embodiments, the alcoholic beverage 105 used in methods 100, 200 and 300 include but are not limited to a spirit, a distilled spirit, a wine, a whiskey, a gin, a brandy, a vodka, a tequila, a scotch, a rum, a bourbon, a beer, a rice wine, or a combination of herein. In some other embodiments, the alcoholic beverage 105 can be either a fresh distilled or an aged alcoholic beverage. The aged alcoholic beverage can be resulted from a traditional barrel aging process or some advanced accelerated aging methods. The aged alcoholic beverage can be aged in a barrel for 2 months, 1 year, 2 years, 3 years, 5 years, 8 years, 10 years, 15 years, 20 years and up to 30 years.

In some embodiments, the natural herb materials 115, 215, 315 are the buds, the flowering tops (flowers), leaves, stalks, seeds, any other portion, or the combination thereof from a Cannabis plant. The Cannabis plant has two main subspecies, Cannabis sativa and Cannabis indica, which have a number of different strains respectively with different content profiles for cannabinoids such as CBD, THC and terpenes. Indica-dominant strains have higher content of CBD than the sativa plants which has higher content of THC. In some embodiments, Cannabis sativa plant materials are used to achieve therapeutic alcoholic beverage compositions with high THC infusion. The resulting therapeutic alcoholic beverage composition has given strong psychoactive responses. In some embodiments, Cannabis indica plant are used to achieve therapeutic alcoholic beverage compositions with high CBD infusion. The resulting therapeutic alcoholic beverage composition has given primary non-psychoactive benefits for reducing pain, controlling anxiety and managing seizures. In some other embodiments, both Cannabis sativa and Cannabis indica materials are used to infuse alcoholic beverage. The resulting therapeutic alcoholic beverage compositions have balanced CBD and THC contents to result in optimal medicinal effects and psychoactive responses. The therapeutic alcoholic beverage also offers unique aroma and flavor profiles from different terpenes in Cannabis strains. The terpenes also provide entourage effects to the psychoactivity of THC or the balanced medicinal effect of CBD and THC. The starting Cannabis materials can be in fresh (with high moisture concentration), dried, or pre-treated conditions.

When Cannabis materials are selected as the natural herb materials 215 in method 200, the materials are pre-treated or activated at step 220 before they are used for infusing with alcoholic beverages. The pre-treatment or activation involves heating Cannabis materials in an oven. The heating temperature ranged from 100° C., 150° C., 200° C., to 250° C., and 300° C. in a time period from 5, 10, 20, 30, 40, 50, 60 minutes to 2, 3, 4, 5, 6, and 12 hours. The heating activates the Cannabis materials by de-carboxylating some cannabinoids into their active forms, the activated Cannabis materials 235. In some embodiments, the cannabidiol acid (CBDA) are activated into CBD. In some other embodiments, Δ⁹-tetrahydrocannabinol acid (THCA) are activated into Δ⁹-THC. In addition, the terpenoids are activated into terpenes which can be readily incorporated into alcoholic beverages to provide aroma and flavor profiles. In some embodiment, the pre-treatment is performed in vacuum or in some inert environment to protect the degradation of Cannabis derived compounds at high temperature.

The subcritical/critical/supercritical CO₂ process 140, 240 or 340 is applied to the infuse compounds derived from natural herb materials and wood materials with alcoholic beverages 105. In some embodiments, the therapeutic herb materials and alcoholic beverages are subjected to subcritical/critical/supercritical carbon dioxide infusion process 140, 240, or 340 which is carried out at or above the critical point of CO₂. The critical point for carbon dioxide is 304.25K at 7.39 MPa or 31.1° C. at 1072 psi or 31.1° C. and 73.8 bar. To perform supercritical treatment, the temperature and pressure may continue to be raised, for example to 55-60° C. with corresponding pressure of 85-100 bar. In some other embodiments, the temperature is raised to 90-100° C. with corresponding pressure of 120-200 bar. The infusion duration under critical/supercritical conditions can last from 5 minutes to 6 hours. Different supercritical CO₂ process parameters (pressure, temperature and duration time) provide different infusion profiles to the enhanced alcoholic beverage compositions.

In the enhancing method 200 as shown in FIG. 2, the wood material 205 is an oak wood from white oak, red oak and other oak species. Different oak species have different aroma and flavor compound profiles. The material can be from the heartwood or sapwood of an oak tree in formats of chips, fibers, particles, granules, sticks, slabs and other formats. In various other embodiments, the wood material 205 can be cherry, hickory, cedar, maple, redwood, palm, chestnut, acacia, apple, alder, pecan, almond, peach, apricot, lemon, birth, beech, plum, walnut, grapefruit, sycamore, or the combination thereof. Also, driftwood from rivers or oceans can be used. Different wood types or combinations present different aroma and flavor profiles to enhance alcoholic beverage compositions. Combinations of various wood materials can be used. In some embodiments, wood materials from historical items such as shipwrecks, ancient buildings, archaeological excavations etc. can be used.

Wood materials 205 are pre-treated or activated at step 210 to obtain activated wood materials 225. In some embodiments, the pre-treatment involves toast or bake the wood materials 205 in an oven. The toasting or baking process can char the wood fiber/chip surfaces. The toast/bake temperature is ranged from 100° C., 150° C., 200° C., to 250° C., 300° C., 350° C., 400° C., 450° C., 500° C. and 600° C. The toast/bake time is ranged from 5, 10, 20, 30, 40, 50, 60 minutes to 2, 3, 4, 5, 6, 8, 10, 12, 18, 24, 36, 48 and 96 hours. In some other embodiments, wood materials can be treated with gas flame to obtain charred wood/charcoal. In some other embodiments, the pretreatment can involve a subcritical/critical/supercritical CO₂ process similar to process step 140 as described in FIG. 1. The pre-treatment activates the wood aroma and flavor compounds.

Activated wood materials 225 present aroma and flavor profiles include but not limit to a flavor of vanilla, buttery, caramel, nutty, clove, toasty, sweet tobacco, charcoal, smoky and the combination thereof.

Activated wood materials 225 and activated natural herb materials 235 are soaked with alcoholic beverage 105 in the presence of subcritical/critical/supercritical CO₂ at step 240 in the enhancing method 200. At or above the critical point of CO₂ (31.1° C. and 73.8 bar), the cannabinoids (CBD and/or THC) and terpenes in activated Cannabis materials 235 and the aroma and flavor compounds in activated oak wood materials 225 are selectively extracted from the materials and infused into alcoholic beverage 105 in situ. This results to a therapeutic and aged alcoholic beverage composition 250 with both medicinal benefits from Cannabis and unique aroma/flavor profiles from oak wood and Cannabis materials. The appearance of the resulting therapeutic and aged alcoholic beverage composition 250 is silky, creamy, bright, etc. with tastes of clean, woody, smoothness, pepper, spicy, musky, cinnamon, etc.

For supercritical CO₂ treatment, the temperature and pressure may continue to be raised above critical point, for example to 40° C., 50° C., 60° C., 70° C., 80° C., 100° C., 200° C., 300° C., 400° C., 500° C. or 600° C. with corresponding pressure of up to 1000 bar. Due to the presence of CO₂, the activated compounds in Cannabis and oak wood materials remain their active form without the damage from high temperatures.

The process 240 duration under subcritical/critical/supercritical conditions can last from 1 minute to 30 days, preferably from 1 hour to 24 hours.

The subcritical/critical/supercritical CO₂ process 240 and 340 increases the surface areas of the wood and subcritical/critical/supercritical CO₂ increases the penetration of CO₂ into wood or herb materials to extract compounds which cannot be extracted by other methods. The process extracts undamaged and unaltered entities from natural herb or wood materials in a natural and mild way.

In some embodiments, the subcritical/critical/supercritical CO₂ process 140, 240 or 340 is repeated more than once. When one process cycle is completed, CO₂ gas is released partially or completely, and the contained materials are cooled down. Fresh CO₂ can be introduced and the subcritical/critical/supercritical CO₂ process 140, 240 or 340 can be repeated multiple times with different cycle parameters (different pressure, temperature, and duration). Infusing process with multiple subcritical/critical/supercritical CO₂ cycles provides higher content of compounds and unique molecule profiles from the materials.

During the enhancing process, the ratios of the natural herb materials and/or wood materials to alcoholic beverage are important for the ultimate quality of therapeutic alcoholic beverage and the enhancing processes. Depending on the wood materials used, the natural herb materials selected, and alcoholic beverage used, the wood to alcoholic beverage ratio is ranged from 0.1 g/L, 5 g/L, 10 g/L, 50 g/L, 100 g/L to 500 g/L and the natural herb material to alcoholic beverage ratio is ranged from 1 mg/L, 10 mg/L, 50 mg/L, 100 mg/L, 500 mg/L, 1000 mg/L, 2000 mg/L to 5000 mg/L.

### EXAMPLES

### Example 1 Pre-Treatment or Activation of Cannabis Materials

About 2 g dried Cannabis material (flowers) was sealed in a foil pouch and placed in an oven at 120° C. for 45 minutes. After completing the heating process, the temperature was reduced to room temperature. Cannabis contained foil pouches were taken out and stored sealed at room temperature. It was not opened until use. After use, the remaining materials should be re-sealed. The resulting materials were tested for standard potency and terpene analyses at Botanacor Laboratories. The activated Cannabis materials contain 120.45 mg/g total potential THC (psychoactive), 15.25 mg/g non-psychoactive CBDs, and 11.64 mg/g terpenes.

### Example 2 Pre-Treatment or Activation of Wood Materials

About 20 g fresh oak wood was split into pieces with about 0.8 g per piece. The oak wood pieces were placed into a supercritical CO₂ chamber which went through a critical point drying (CPD) process. The temperature and pressure were kept at about 50° C. and 900 psi, respectively for 60 minutes. The total cycle time was about 60 minutes. After that, the pieces were taken out from the chamber and sealed into a foil pouch. It was then heated in an oven to about 200° C. for 90 minutes. The temperature was naturally cooled down to room temperature. Oak wood contained foil pouches were taken out and stored sealed at room temperature. It was not opened until use. After use, the remaining materials should be re-sealed.

### Example 3 Therapeutic Tequila with Cannabis Derivatives

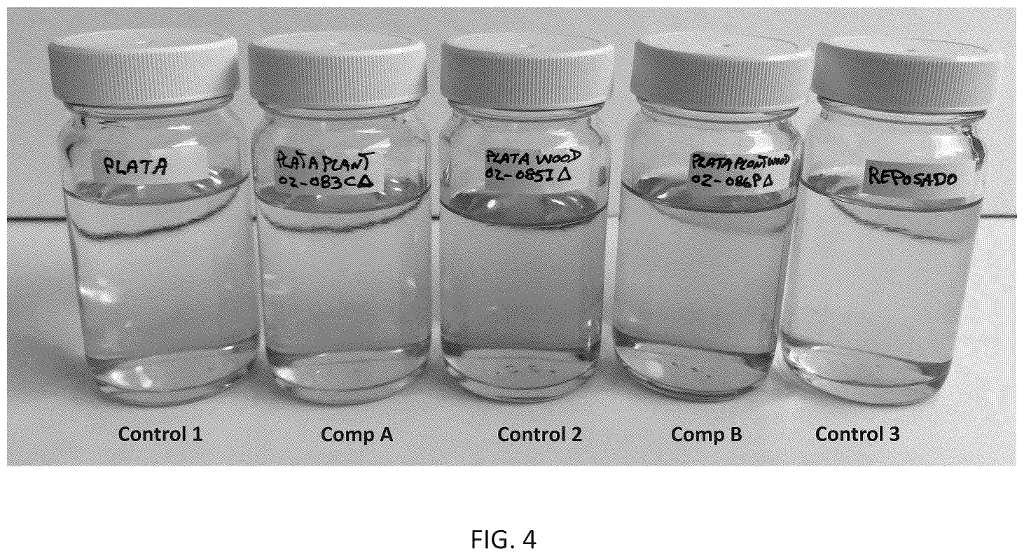

100% agave tequila (Plata, distilled without aging) was obtained from a liquor store. About 0.05 g pre-treated Cannabis flowers were added to about 50 ml Plata tequila in a supercritical CO₂ chamber which went through a supercritical enhancing and infusing process. The temperature and pressure were kept at about 55° C. and 1500 psi, respectively. The cycle time was about 2 hours. After the process was completed, the chamber was cooled down naturally and CO₂ was released to obtain resulting enhanced tequila composition A (Comp A). The process was repeated using Extra Anejo tequila to obtain enhanced tequila composition AA (not shown). As shown in FIG. 4, Comp A shows slight change of color from crystal clear of Plata tequila (Control 1) and has rich Cannabis aromas and flavors. Comp A contains 0.17 mg/ml psychoactive THC as tested by Trace THC analysis.

### Example 4 Therapeutic and Aged Tequila with Derivatives from Cannabis and Oak Wood Materials

100% agave tequila (Plata, distilled without aging) was obtained from a liquor store. About 0.05 g pre-treated Cannabis flowers and 0.8 g pre-treated oak wood were soaked in about 50 ml Plata tequila in a supercritical CO₂ chamber which went through a supercritical enhancing and infusing process. The temperature and pressure were kept at about 55° C. and 1500 psi, respectively. The cycle time was about 2 hours. After the process was completed, the chamber was cooled down naturally and CO₂ was released to obtain resulting enhanced tequila composition B. The process was repeated using Extra Anejo tequila to obtain enhanced tequila composition BB. As shown in FIG. 4, composition B (Comp B) shows golden color which is richer than Reposado tequila (Control 3) and has both Cannabis and oak wood aromas and flavors. The rich color was mainly the result of oak wood derived compounds as it is shown in comparison with Control 2 (oak wood only and without Cannabis materials) in FIG. 4. Composition BB is not shown.

### Example 5 Therapeutic and Aged Tequila with Derivatives from Cannabis and Oak Wood Materials—High Temperature

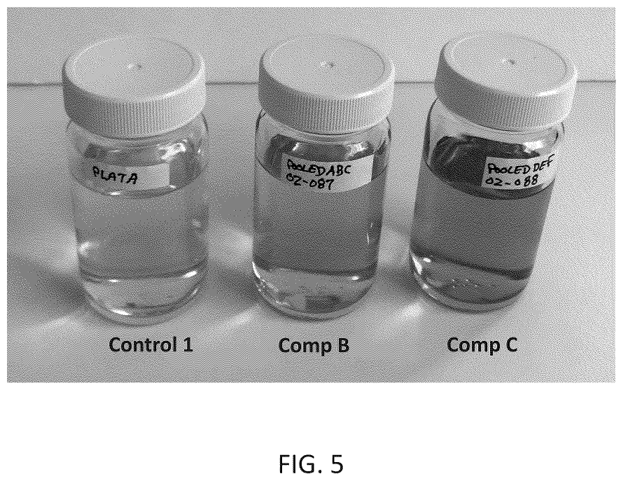

100% agave tequila (Plata, distilled without aging) was obtained from a liquor store. About 0.05 g pre-treated Cannabis flowers and 0.8 g pre-treated oak wood were soaked in about 50 ml Plata tequila in a supercritical CO₂ chamber which went through a supercritical enhancing and infusing process. The temperature and pressure were kept at about 95° C. and 2200 psi, respectively. The cycle time was about 4 hours. After the process was completed, the chamber was cooled down naturally and CO₂ was released to obtain resulting enhanced tequila composition C. As shown in FIG. 5, composition C (Comp C) shows rich golden color which much richer than Comp B. The appearance was close to Extra Anejo tequila which has been aged in an oak wood barrel for 5 years.

### Example 6 Therapeutic Tequila with Magic Mushroom Derivatives

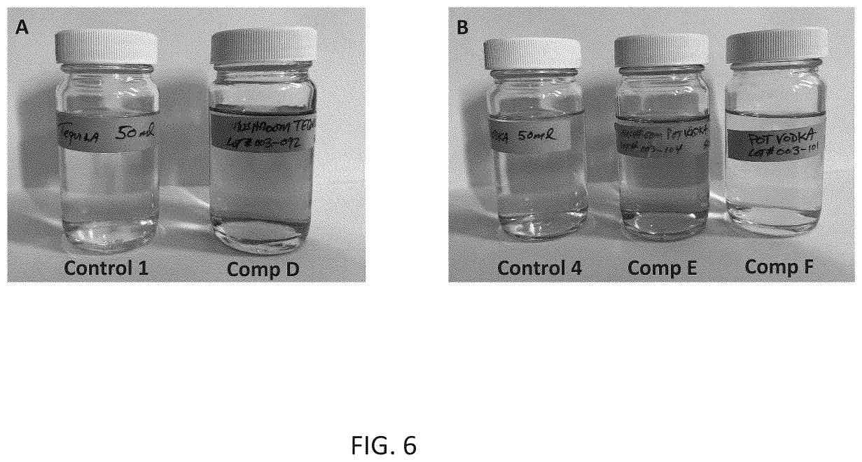

100% agave tequila (Plata, distilled without aging) was obtained from a liquor store. About 1.0 g magic mushroom materials were added to about 750 ml Plata tequila in a supercritical CO₂ chamber which went through a supercritical enhancing and infusing process. The temperature and pressure were kept at about 55° C. and 1500 psi, respectively. The cycle time was about 2 hours. After the process was completed, the chamber was cooled down naturally and CO₂ was released to obtain resulting enhanced tequila composition D. As shown in FIG. 6A, composition D (Comp D) shows slight change of color from crystal clear of Plata tequila (Control 1). The therapeutic tequila has 0.009 mg/ml psilocin as tested by psilocybin analysis at BriteBox Labs, Inc.

### Example 7 Therapeutic Vodka with Both Cannabis Materials and Psilocybin Mushroom Derivatives

Prairie organic vodka was obtained from a liquor store. About 1.0 g pre-treated Cannabis flowers and 1.0 g psilocybin mushroom were added to about 750 ml organic vodka in a supercritical CO₂ chamber which went through a supercritical enhancing and infusing process. The temperature and pressure were kept at about 55° C. and 1500 psi, respectively. The cycle time was about 2 hours and repeated twice. After the process was completed, the chamber was cooled down naturally and CO₂ was released to obtain resulting therapeutic vodka E. As shown in FIG. 6B, composition E shows slight change of color from crystal clear of Prairie Vodka (Control3) and Prairie Vodka infused with Cannabis materials only (Comp F).

The foregoing descriptions have been presented for purposes of illustration and description and are not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although the invention has been described with reference to preferred embodiments, persons skilled in the art will recognize that changes may be made in form and detail without departing from the alcoholic beverage and scope of the invention.

The flowchart and block diagrams in the Figures illustrate the architecture, functionality, and operation of possible implementations of systems, and methods according to various embodiments of the present technology. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments.

What is claimed is:

1. A therapeutic alcoholic beverage composition comprising:
an alcoholic beverage;
a psychoactive or non-psychoactive compound derived from Cannabis materials;
a psychedelic compound derived from psilocybin mushrooms.

2. The composition of claim 1, wherein said psychoactive or non-psychoactive compound comprising Δ⁹-tetrahydrocannabinol (THC), cannabidiol (CBD), terpenes or the combinations thereof.

3. The composition of claim 1, wherein said psychedelic compound comprising psilocybin, psilocin, baeocystin, norbaeocystin, norpsilocin or the combinations thereof.

4. The composition of claim 1, wherein said psychoactive/non-psychoactive or psychedelic compounds have a weight ratio of 0.00001% to 10% in the alcoholic beverage.

5. The composition of claim 1, wherein the weight ratio of said psychoactive compounds to psychedelic compounds is from 1:100 to 100:1.

6. The composition of claim 1, wherein said alcoholic beverage is selected from the group consisting of tequila, whiskey, scotch, gin, brandy, vodka, rum, bourbon, wine, and beer.

7. The composition of claim 1, wherein said beverage is an aged alcoholic beverage selected from the group consisting of tequila, whiskey, scotch, gin, brandy, vodka, rum, bourbon, wine, and beer.

8. The composition of claim 7, wherein said aged alcoholic beverage is aged from 1 day to 30 years in a wood barrel.

9. The composition of claim 1, wherein said therapeutic alcoholic beverage composition further comprising an aroma and flavor compound derived from a wood material in a weight ratio of 0.00001% to 10% in the alcoholic beverages.

10. The composition of claim 9, wherein said aroma and flavor compound comprising vanillin, oak lactone, furfural/methylfurfural, eugenol/isoeugenol, guaiacol/methylguaiacol, or the combination thereof.

11. A method of making therapeutic alcoholic beverage, the method comprising the steps of:
providing an alcoholic beverage;
providing natural herb materials;
contacting and treating the alcoholic beverages with said natural herb materials in a processing vessel, in presence of carbon dioxide wherein the carbon dioxide conditions are selected from the group consisting of subcritical, critical or supercritical conditions wherein the contact time under said condition is between 5 minutes to 24 hours to produce a therapeutic alcoholic beverage;
removing said treated alcoholic beverage from said processing vessel and storing in a second vessel or a container.

12. A method of making therapeutic alcoholic beverage, the method comprising the steps of:
providing an alcoholic beverage;
providing natural herb materials;
providing wood materials;
contacting and treating the alcoholic beverage with said natural herb materials and said wood materials in a processing vessel, in presence of carbon dioxide wherein the carbon dioxide conditions are selected from the group consisting of subcritical, critical or supercritical conditions wherein the contact time under said condition is between 5 minutes to 24 hours to produce a therapeutic and aged alcoholic beverage;
removing said treated alcoholic beverage from said processing vessel and storing in a second vessel or a container.

13. The method of claim 11 and 12, wherein said natural herb material is selected from a group consisting of Cannabis materials, psilocybin mushrooms or the combination thereof.

14. The method of claim 13, wherein the selected Cannabis materials are subject to toasting or baking at a temperature from 100° C. to 300° C. for 10 minutes to 6 hours.

15. The method of claim 14, wherein toasting or baking the Cannabis materials is performed in an oxygen free environment.

16. The method of claim 12, wherein providing wood materials comprising toasting or charring wood materials at a temperature from 60° C. to 500° C. for 5 minutes to 96 hours.

17. The method of claim 11 and 12, wherein the carbon dioxide conditions for subcritical, critical or supercritical conditions is at a pressure from 50 bar to 600 bar and a temperature from 20° C. to 150° C.

18. The method of claim 11 and 12, wherein the ratio of the natural herb materials to the alcoholic beverage is from 1:10 to 1:10000.

19. The method of claim 12, wherein the ratio of the wood materials to the alcoholic beverage is from about 1:10 to about 1:1000.

20. The method of claim 11 and 12, wherein the contacting and treating step is repeated one or more times.
